(19) United States
(12) Patent Application Publication
(10) Pub. No.: US 2022/0237837 A1
(43) Pub. Date: Jul. 28, 2022

(54) DISPLAY DEVICE, DISPLAY METHOD, AND NON-TRANSITORY COMPUTER-READABLE MEDIUM

(71) Applicant: NEC Corporation, Tokyo (JP)

(72) Inventor: Takayuki KURODA, Tokyo (JP)

(73) Assignee: NEC Corporation, Tokyo (JP)

(21) Appl. No.: 17/577,655

(22) Filed: Jan. 18, 2022

(30) Foreign Application Priority Data
Jan. 27, 2021 (JP) 2021-011412

(51) Int. Cl. G06T 11/20; G06F 3/14

(52) U.S. Cl. CPC G06T 11/206; G06F 3/14

(57) ABSTRACT

A display device according to the present disclosure includes: an input unit inputting an initial graph structure and a conversion content; a change application unit refining the initial graph structure by successively applying the conversion content, successively applying the conversion content to the initial graph structure while leaving a component deleted in a process of the refinement, and thereby generating an aggregated graph structure; and a display unit displaying one graph structure of the plurality of graph structures at the same position on a screen. The change application unit determines, on a screen, a position of the component in such a way that the components existing in the aggregated graph do not overlap, and the display unit displays, in display of the one graph structure, the component existing in the one graph structure at the same position, on a screen, as a position determined in the aggregated graph structure.

### INCORPORATION BY REFERENCE

This application is based upon and claims the benefit of priority from Japanese patent application No. 2021-011412, filed on Jan. 27, 2021, the disclosure of which is incorporated herein in its entirety by reference.

### TECHNICAL FIELD

The present disclosure relates to a display device, a display method, and a non-transitory computer-readable medium.

### BACKGROUND ART

There is a technique referred to as system automatic design in which design of a computer system, an Internet of things (IoT) system, an information and communication technology (ICT) system, and the like is performed automatically.

The system automatic design is achieved by gradually converting abstract configuration information into specific and refined configuration information. Configuration information is expressed by a graph structure using a component (also referred to as a node) of a system and a relationship (also referred to as an edge) between the two components. In addition, it is also performed that a design process of automatic design is displayed on a display device in such a way that a user can understand the design process. International Patent Publication No. WO2019/216082 discloses such system automatic design.

In the automatic design, the configuration information is gradually refined as described above. Therefore, when displaying the design process of the automatic design, it is necessary to display each piece of configuration information in the design process which is gradually refined.

As a display device for displaying a graph structure, for example, a display device disclosed in Japanese Unexamined Patent Application Publication No. 2014-197279 is cited.

According to the display device disclosed in Japanese Unexamined Patent Application Publication No. 2014-197279, a plurality of graph structures each constituted of a plurality of elements are acquired, a non-changing element that does not change in the plurality of graph structures and a changing element that has changed between the plurality of graph structures are discriminated among the plurality of elements, the plurality of graph structures are aggregated, and the aggregated graph structure is displayed in such a way that the changing element and the non-changing element can be identified.

According to the display device disclosed in Japanese Unexamined Patent Application Publication No. 2014-197279, a plurality of graph structures are a graph structure at a plurality of time points along a time series, and it is also possible to display a graph structure associated with one time point. When displaying the graph structure associated with one time point, a node is displayed at the same position as a position in the aggregated graph structure.

As described above, according to the display device disclosed in Japanese Unexamined Patent Application Publication No. 2014-197279, it is possible to display an aggregated graph structure and a graph structure associated with one time point.

However, in the display device disclosed in Japanese Unexamined Patent Application Publication No. 2014-197279, it is necessary to input a plurality of graph structures and discriminate between a non-changing element that does not change in the plurality of graph structures and a changing element that has changed between the plurality of graph structures, and there is a problem that a processing speed for displaying the graph structure is lowered and a processing time is increased because a processing load for the discrimination is large.

### SUMMARY

An object of the present disclosure is to solve the above-described problem, and is to provide a display device, a display method, and a non-transitory computer-readable medium that are capable of displaying a graph structure in a design process of automatic design without causing a decrease in a processing speed or an increase in a processing time being associated with display of the graph structure.

A display device according to one aspect includes: an input unit that inputs an initial graph structure represented by using a component and a relationship between the two components, and also inputs a conversion content representing a rule for partially converting a graph structure; a change application unit that refines the initial graph structure by successively applying the conversion content to the initial graph structure, successively applies the conversion content to the initial graph structure while leaving a component deleted in a process of the refinement, and thereby generates an aggregated graph structure equivalent to a graph structure acquired by aggregating, into one graph structure, a plurality of graph structures constituted of the initial graph structure and graph structures each acquired in the process of the refinement; and a display unit that displays one graph structure of the plurality of graph structures at the same position on a screen, wherein the change application unit determines a position, on a screen, of the component existing in the aggregated graph structure in such a way that the components existing in the aggregated graph structure do not overlap with each other, in the aggregated graph structure, and the display unit displays, in display of the one graph structure, the component existing in the one graph structure at the same position, on a screen, as a position determined in the aggregated graph structure.

A display method according to one aspect is a display method to be executed by a display device, the method including: an input step of inputting an initial graph structure represented by using a component and a relationship between the two components, and also inputting a conversion content representing a rule for partially converting a graph structure; an application step of refining the initial graph structure by successively applying the conversion content to the initial graph structure, successively applying the conversion content to the initial graph structure while leaving a component deleted in a process of the refinement, and thereby generating an aggregated graph structure equivalent to a graph structure acquired by aggregating, into one graph structure, a plurality of graph structures constituted of the initial graph structure and graph structures each acquired in the process of the refinement; and a display step of displaying one graph structure of the plurality of graph structures at the same position on a screen, wherein, in the application step, a position, on a screen, of the component existing in the aggregated graph structure is determined in such a way that the components existing in the aggregated graph structure do not overlap with each other, in the aggregated graph structure, and, in the display step, in display of the one graph structure, the component existing in the one graph structure is displayed at the same position, on a screen, as a position determined in the aggregated graph structure.

A non-transitory computer-readable medium according to one aspect is a non-transitory computer-readable medium storing a program for causing a computer to execute, the program including: an input procedure of inputting an initial graph structure represented by using a component and a relationship between the two components, and also inputting a conversion content representing a rule for partially converting a graph structure; an application procedure of refining the initial graph structure by successively applying the conversion content to the initial graph structure, successively applying the conversion content to the initial graph structure while leaving a component deleted in a process of the refinement, and thereby generating an aggregated graph structure equivalent to a graph structure acquired by aggregating, into one graph structure, a plurality of graph structures constituted of the initial graph structure and graph structures each acquired in the process of the refinement; and a display procedure of displaying one graph structure of the plurality of graph structures at the same position on a screen, wherein, in the application procedure, a position, on a screen, of the component existing in the aggregated graph structure is determined in such a way that the components existing in the aggregated graph structure do not overlap with each other, in the aggregated graph structure, and, in the display procedure, in display of the one graph structure, the component existing in the one graph structure is displayed at the same position, on a screen, as a position determined in the aggregated graph structure.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration example of a display device according to a first example embodiment;

FIG. 2 is a diagram illustrating an example of an initial graph structure and a conversion content being input to an input unit according to the first example embodiment;

FIG. 3 is a diagram illustrating a specific example of an operation of a change application unit according to the first example embodiment;

FIG. 4 is a diagram illustrating a specific example of the operation of the change application unit according to the first example embodiment;

FIG. 5 is a diagram illustrating an example of a display method according to a comparative example;

FIG. 6 is a diagram illustrating an example of a display method according to a comparative example;

FIG. 7 is a diagram illustrating an example of a display method according to a comparative example;

FIG. 8 is a diagram illustrating an example of a display method according to the first example embodiment;

FIG. 9 is a diagram illustrating a specific display example of a graph structure by a display unit according to the first example embodiment;

FIG. 10 is a diagram illustrating a specific display example of the graph structure by the display unit according to the first example embodiment;

FIG. 11 is a diagram illustrating a specific display example of the graph structure by the display unit according to the first example embodiment;

FIG. 12 is a flow chart illustrating an example of a flow of a schematic operation of the display device according to the first example embodiment; and

FIG. 13 is a block diagram illustrating an example of a hardware configuration of a display device according to a second example embodiment.

### EXAMPLE EMBODIMENTS

Example embodiments of the present disclosure will be described below with reference to the drawings. Note that, the following description and the drawings are appropriately omitted and simplified for clarity of the description. Further, in the following drawings, the same elements are denoted by the same reference signs, and a repetitive description thereof is omitted as necessary.

### First Example Embodiment

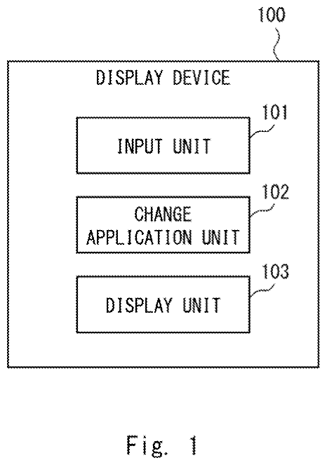

First, a configuration example of a display device 100 according to a first example embodiment will be described with reference to FIG. 1. As illustrated in FIG. 1, the display device 100 according to the first example embodiment includes an input unit 101, a change application unit 102, and a display unit 103.

An initial graph structure is input to the input unit 101, and a conversion content representing a rule for partially converting the graph structure is input to the input unit 101. The graph structure is, for example, configuration information of automatic design.

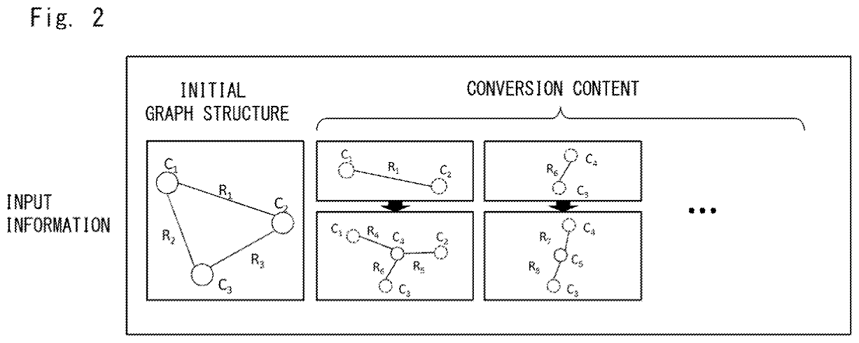

FIG. 2 illustrates an example of the initial graph structure and the conversion content input to the input unit 101. As illustrated in FIG. 2, the graph structure is represented by using a component (components C₁, C₂, and C₃ in the figure) of a system and a relationship between the two components (relationships R₁, R₂, and R₃ in the figure). For example, the relationship R₁ defines a relationship between the two components C₁ and C₂. Further, the conversion content consists of a pair of a partial structure in the graph structure (a structure at an upper part in the figure) and a structure after one conversion of the partial structure (a structure at a lower part in the figure). Note that, as illustrated in FIG. 2, it is assumed that a plurality of conversion contents are input to the conversion contents.

The change application unit 102 successively applies the conversion content being input to the input unit 101 to the initial graph structure being input to the input unit 101.

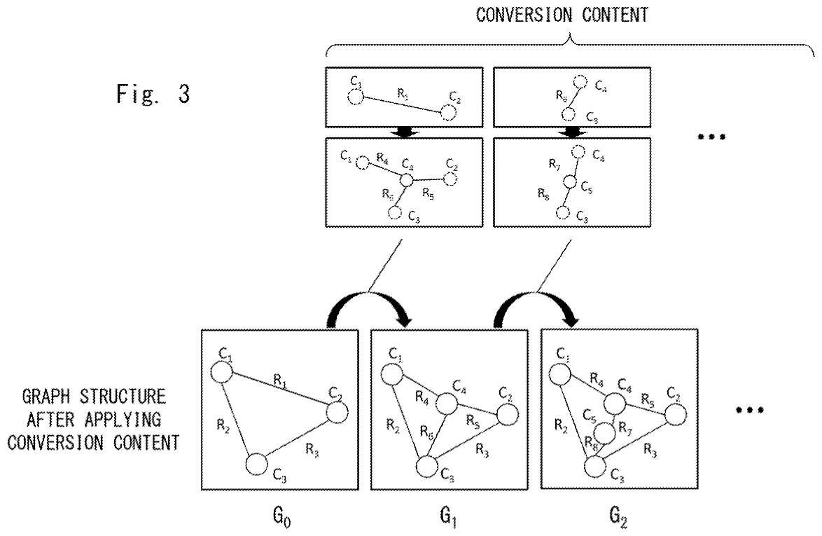

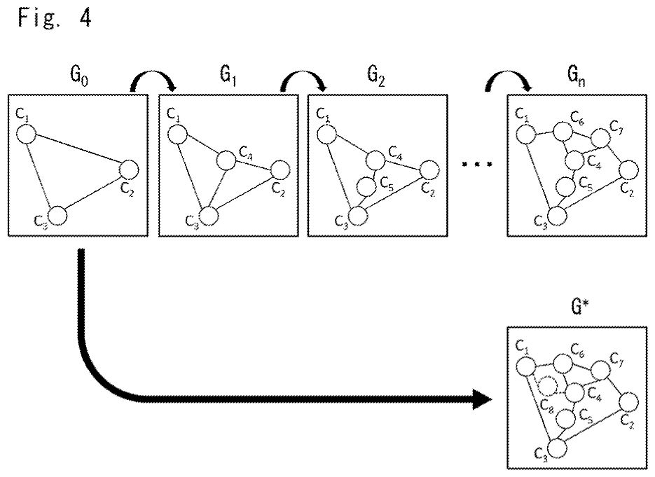

FIGS. 3 and 4 illustrate specific examples of an operation of the change application unit 102. As illustrated in FIG. 3, first, the change application unit 102 performs an operation of converting a partial structure that is in an initial graph structure G₀ and matches the structure of the upper part of the conversion content into a structure of the lower part of the conversion content, and thereby acquires a graph structure G₁. Herein, the same ID (identifier) as each component and each relationship in the graph structure to which the conversion content is applied is assigned to each component and each relationship in the structure of the upper part of the conversion content. Therefore, the change application unit 102 may determine that the conversion content with which the component and relationship in the upper part of the structure have the same ID as those of the component and relationship in the initial graph structure G₀ is applied to the initial graph structure G₀, and apply the conversion content. Next, the change application unit 102 performs a similar operation on a graph structure G₁, and acquires a graph structure G₂.

The change application unit 102 successively performs such an operation on the input initial graph structure (i.e., the graph structure illustrated in a left end of FIG. 2) with reference to each of the similarly input conversion contents (i.e., each of the conversion contents illustrated in FIG. 2). At this time, in a process of successively applying each of the conversion contents to the initial graph structure, a component existing in a certain step may be deleted in the graph structure in another step as a result of applying the conversion content in the another step subsequent to the next step.

As illustrated in FIG. 3, the change application unit 102 successively applies the conversion content to the initial graph structure G₀, and thereby refines the initial graph structure G₀ and finally acquires the refined graph structure Gₙ, as illustrated in FIG. 4. Thus, in a process of refinement, the graph structures G₁ to Gₙ are acquired.

On the other hand, as illustrated in FIG. 4, the change application unit 102 successively applies the conversion content to the initial graph structure G₀ while leaving the component deleted in the process of the refinement. As a result, an aggregated graph structure G* is generated, which corresponds to a graph structure acquired by aggregating, into one graph structure, a plurality of graph structures G₀ to Gₙ constituted of the initial graph structure G₀ and the graph structures G₁ to Gₙ each acquired in the process of the refinement. For example, in the example in FIG. 4, a component C₈ indicated by a dotted circle is deleted in the process of the refinement, but is left in the aggregated graph structure G*.

The display unit 103 displays a plurality of graph structures acquired by the change application unit 102, i.e., each of the plurality of graph structures constituted of the initial graph structure and graph structures each acquired in the process of the refinement.

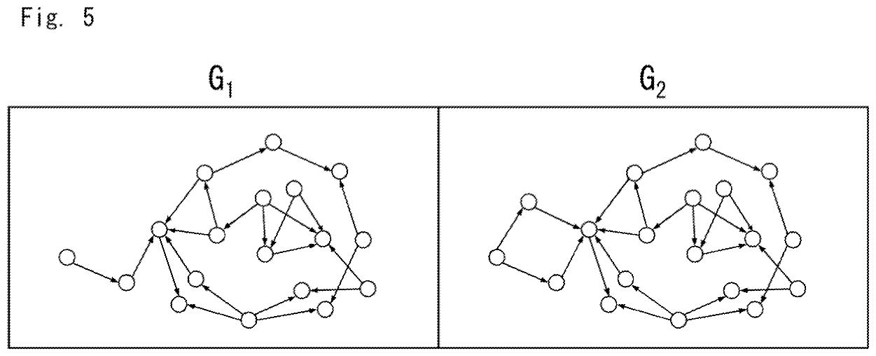

Herein, a display method for displaying each of a plurality of graph structures according to the first example embodiment will be described including an examination result examined by the present inventor. Note that, FIGS. 5 to 7 described below are display methods according to a comparative example examined by the present inventor.

In FIG. 5, two graph structures G₁ and G₂ before and after one conversion are displayed side by side. However, even when the two graph structures G₁ and G₂ before and after one conversion are displayed side by side, it is difficult for a user to instantaneously recognize a difference between the two graph structures G₁ and G₂, and as a result, it is considered that it is difficult to understand the entire design process of the automatic design. This becomes more remarkable as the target graph structures G₁ and G₂ become larger. Note that, although the two graph structures G₁ and G₂ are displayed horizontally side by side in the example in FIG. 5, it is also considered that it is difficult to recognize the difference between the two graph structures G₁ and G₂ similarly to a case where the two graph structures G₁ and G₂ are displayed vertically side by side.

Therefore, in the first example embodiment, the display unit 103 displays one graph structure among the plurality of graph structures acquired by the change application unit 102 at the same position on a screen. At this time, the display unit 103 may successively display a plurality of graph structures as one graph structure in time series order. Alternatively, the display unit 103 may display one graph structure selected by a user among a plurality of graph structures.

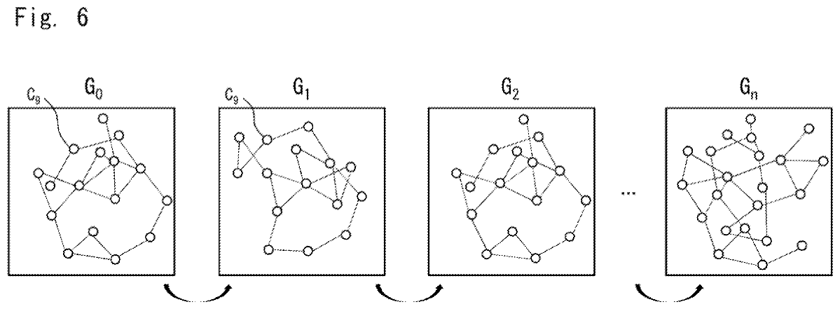

However, even when one graph structure is displayed in the display unit 103, in a case where each component existing in one graph structure does not have position information on the screen, there is a possibility that the component existing in both of the two graph structures is displayed at different positions on the screen in the two graph structures before and after one conversion. For example, in the example in FIG. 6, it is assumed that a component C₉ exists in both of the two graph structures G₀ and G₁ before and after one conversion, but does not have position information. In this case, the component C₉ is displayed at a different position in the two graph structures G₀ and G₁.

Therefore, even when one graph structure is displayed in the display unit 103, in a case where the component existing in both of the two graph structures before and after one conversion is displayed at different positions on the screen, it is considered that it is difficult for a user to instantaneously recognize the difference between the two graph structures.

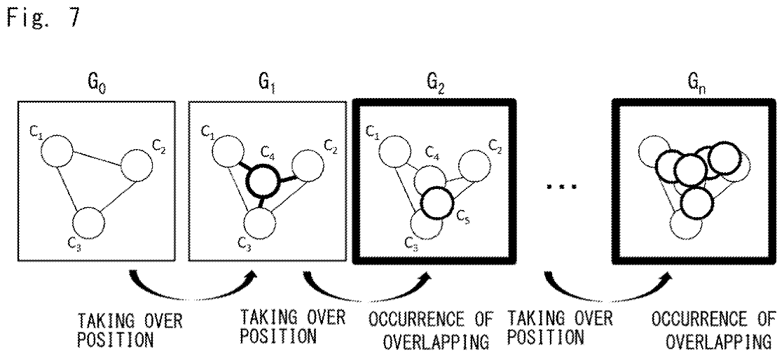

Then, in the first example embodiment, it is assumed that each component has position information on the screen. However, when a component existing in both of two graph structures before and after one conversion simply takes over position information in the graph structure before the conversion even in the graph structure after the conversion, there is a possibility that the components overlap with each other. For example, in the example in FIG. 7, a component C₅ is added to the graph structure G₂. However, existing components C₃ and C₄ take over the position information in the previous components C₃ and C₄, and as a result, the overlap between the component C₅ and the existing components C₃ and C₄ occurs.

Therefore, when displaying one graph structure in the display unit 103, in order to avoid occurrence of overlap the components existing in one graph structure with each other, it is necessary to provide position information on the screen to each component, in anticipation of the subsequent refinement.

Then, in the first example embodiment, as described by using FIG. 4, the change application unit 102 generates the aggregated graph structure G* equivalent to a graph structure acquired by aggregating, into one graph structure, a plurality of graph structures constituted of the initial graph structure G₀ and the graph structures G₁ to Gₙ each acquired in the process of the refinement.

Then, the change application unit 102 determines a position, on the screen, of components C₁ to C₈ existing in the aggregated graph structure G* in such a way that the components C₁ to C₈ existing in the aggregated graph structure G* do not overlap in the aggregated graph structure G with one another, and gives the determined position information to the components C₁ to C₈, respectively.

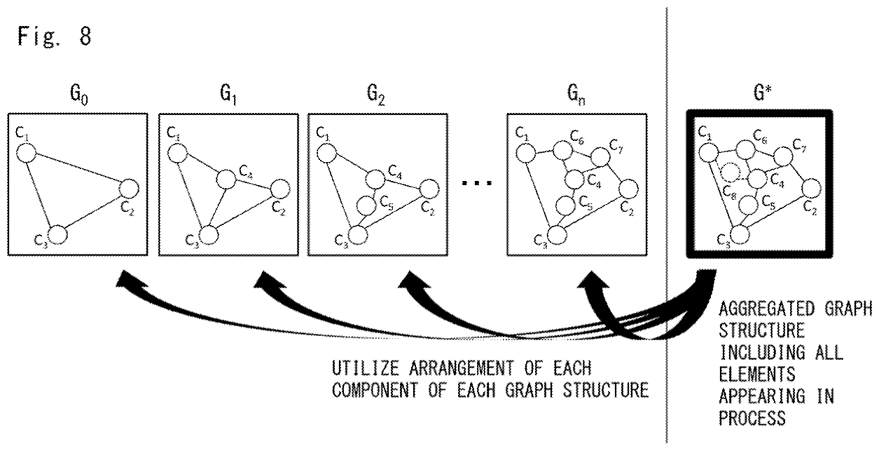

When displaying one graph structure among the plurality of graph structures, as illustrated in FIG. 8, the display unit 103 displays the component existing in the one graph structure at the same position as the position, on the screen, determined at the aggregated graph structure G*, in response to the position information having by the component. For example, in the example in FIG. 8, when displaying the graph structure G₁, the display unit 103 displays the components C₁ to C₄ existing in the graph structure G₁ at the same position as the position, on the screen, determined by the aggregated graph structure G*.

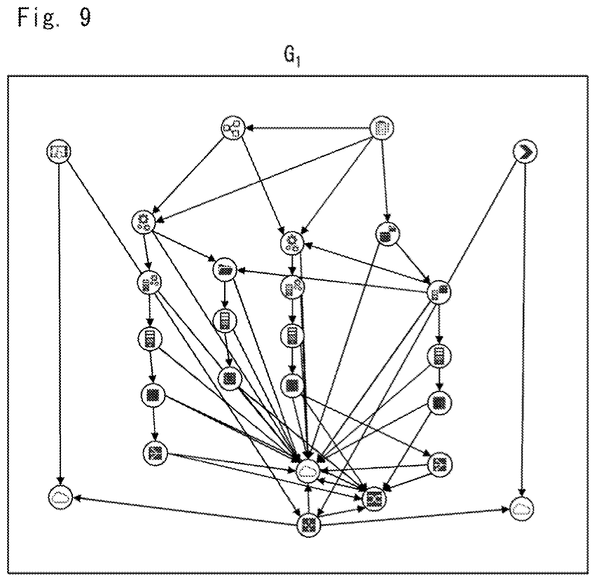

Herein, a specific display example of the graph structure by the display unit 103 will be described with reference to FIGS. 9 to 11. Herein, it is assumed that the display unit 103 successively displays graph structures G₁ to G₃ in time series order. Further, it is assumed herein that the graph structures G₁ to G₃ are arranged in the order of time series.

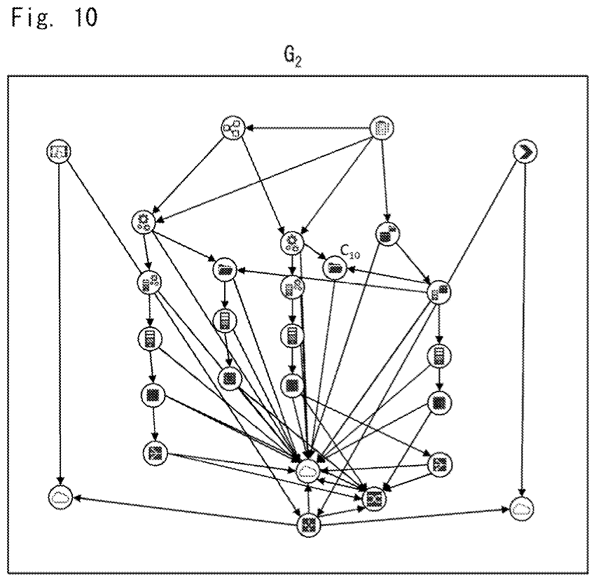

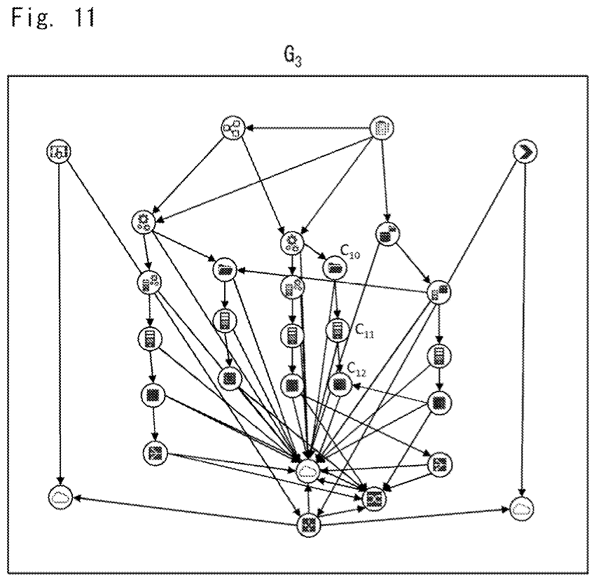

As illustrated in FIGS. 9 to 11, the display unit 103 successively displays the graph structures G₁ to G₃ in this order at the same position on the screen. At this time, the display unit 103 displays the components existing in the graph structures G₁ to G₃ at the same position as the position, on the screen, determined by the aggregated graph structure. In the examples in FIGS. 9 to 11, a difference between the graph structure G₁ (FIG. 9) and the graph structure G₂ (FIG. 10) lies in a point that a component C₁₀ is added and a point that some relationships are changed with the addition of the component C₁₀. Further, a difference between the graph structure G₂ (FIG. 10) and the graph structure G₃ (FIG. 11) lies in a point that components C₁₁ and C₁₂ are added and a point that some relationships are changed with the addition of the components C₁₁ and C₁₂.

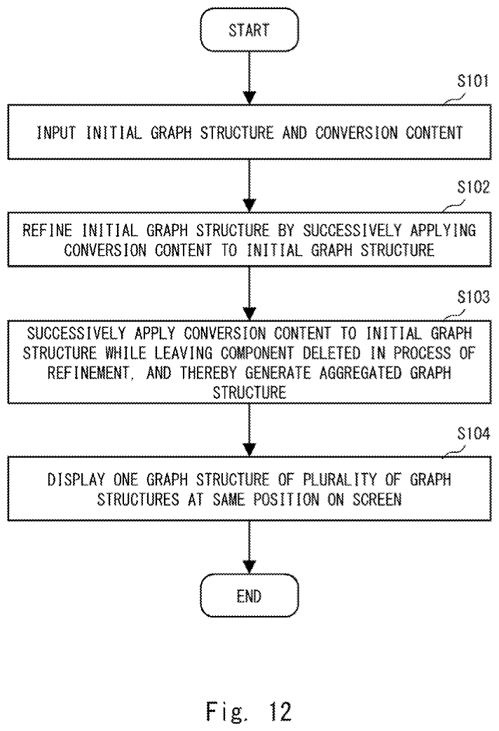

Next, an example of a flow of a schematic operation of the display device 100 according to the first example embodiment will be described with reference to FIG. 12.

As illustrated in FIG. 12, first, the input unit 101 inputs an initial graph structure and a conversion content (step S101).

Next, the change application unit 102 successively applies the conversion content to the initial graph structure, and thereby refines the initial graph structure (step S102).

Next, the change application unit 102 successively applies the conversion content to the initial graph structure while leaving a component deleted in the process of the refinement, and thereby generates an aggregated graph structure equivalent to a graph structure acquired by aggregating, into one graph structure, a plurality of graph structures constituted of the initial graph structure and graph structures each acquired in the process of the refinement (step S103). At this time, the change application unit 102 determines a position, on a screen, of the component existing in the aggregated graph structure in such a way that the components existing in the aggregated graph structure do not overlap with each other in the aggregated graph structure.

Thereafter, the display unit 103 displays one graph structure of the plurality of graph structures at the same position on the screen (step S104). At this time, the display unit 103 displays the component existing in one graph structure at the same position, on the screen, as the position determined by the aggregated graph structure.

As described above, according to the first example embodiment, the input unit 101 inputs an initial graph structure and a conversion content. The change application unit 102 refines the initial graph structure by successively applying the conversion content to the initial graph structure, and successively applies the conversion content to the initial graph structure while leaving a component deleted in the process of the refinement, and thereby generates an aggregated graph structure. The aggregated graph structure corresponds to a graph structure acquired by aggregating, into one graph structure, a plurality of graph structures constituted of the initial graph structure and graph structures each acquired in the process of the refinement. The display unit 103 displays one graph structure of the plurality of graph structures at the same position on the screen.

In other words, according to the first example embodiment, the initial graph structure and the conversion content are input, and a plurality of graph structures are acquired by using them. Therefore, it is not necessary to acquire a plurality of graph structures by input as in Japanese Unexamined Patent Application Publication No. 2014-197279.

Further, according to the first example embodiment, the aggregated graph structure is generated by successively applying the conversion content to the initial graph structure while leaving the component deleted in the process of the refinement. Therefore, when generating the aggregated graph structure, it is not necessary to discriminate between a non-changing element that does not change in a plurality of graph structures and a changing element that has changed between the plurality of graph structures, as in Japanese Unexamined Patent Application Publication No. 2014-197279. Furthermore, according to the first example embodiment, one graph structure of the plurality of graph structures is displayed. Therefore, there is no need to display an aggregated graph structure as in Japanese Unexamined Patent Application Publication No. 2014-197279.

Therefore, according to the first example embodiment, since it is not necessary to input a plurality of graph structures, refer to the plurality of graph structures, and discriminate the non-changing element and the changing element, a load of processing required for the discrimination as in Japanese Unexamined Patent Application Publication No. 2014-197279 does not occur. As a result, according to the first example embodiment, without causing a decrease in a processing speed and an increase in a processing time associated with the display of the graph structure, it is possible to achieve a high-speed display which is not affected by information having a large processing load associated with a design process, even when, for example, it is adopted for subsequent confirmation by a user of the graph structure in the design process in the system automatic design as disclosed in International Patent Publication No. WO2019/216082.

Further, according to the first example embodiment, the same ID as the component and the relationship in the graph structure to which the conversion content is applied is assigned to the component and the relationship in the conversion content, and the change application unit 102 determines the conversion content to be applied to the graph structure by comparing the IDs. Therefore, the conversion content to be applied to the graph structure can be determined by extremely simply comparing the IDs. As a result, the processing speed for displaying the graph structure can be further increased.

Further, according to the first example embodiment, the change application unit 102 determines the position, on the screen, of the component existing in the aggregated graph structure in such a way that the components existing in the aggregated graph structure do not overlap with each other in the aggregated graph structure. In the display of one graph structure, the display unit 103 displays the component existing in one graph structure at the same position as the position, on the screen, determined by the aggregated graph structure.

Therefore, according to the first example embodiment, in the display of one graph structure, overlapping of components existing in one graph structure is avoided. Further, it is also ensured that the components existing in both of the two graph structures before and after one conversion are displayed at the same position on the screen even when displaying either of the two graph structures before and after the conversion. As a result, a user can easily recognize the difference between the two graph structures before and after one conversion, and as a result, can easily understand the entire design process of the automatic design.

### Second Example Embodiment

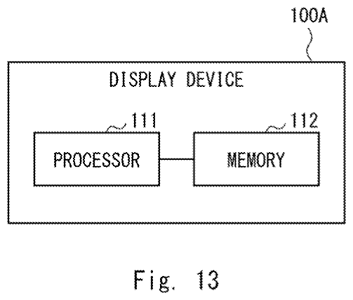

Next, a hardware configuration example of a display device 100A according to a second example embodiment will be described with reference to FIG. 13. As illustrated in FIG. 13, the display device 100A according to the second example embodiment includes a processor 111 and a memory 112.

The processor 111 may be, for example, a microprocessor, a micro processing unit (MPU), or a central processing unit (CPU). The processor 111 may include a plurality of processors.

The memory 112 is constituted of a combination of a volatile memory and a nonvolatile memory. The memory 112 may include a storage located away from the processor 111. In this case, the processor 111 may access the memory 112 via a non-illustrated input(I)/output(O) interface.

The display device 100 according to the first example embodiment described above can have the hardware configuration illustrated in FIG. 13. The input unit 101, the change application unit 102, and the display unit 103 in the display device 100 described above may be achieved by causing the processor 111 to read a program stored in the memory 112 and execute the program.

The program described above also include an instruction group (or software code) that, when read into a computer, causes the computer to perform one or more of functions described in the example embodiments. The program may be stored on a non-transitory computer-readable medium or a tangible storage medium. By way of an example, and not limitation, a non-transitory computer-readable medium or a tangible storage medium includes a random-access memory (RAM), a read-only memory (ROM), a flash memory, a solid-state drive (SSD), or other memory technology, a CD-ROM, a digital versatile disc (DVD), a Blu-ray disc, or other optical disk storage, a magnetic cassette, a magnetic tape, a magnetic disk storage, or other magnetic storage device. The program may be transmitted over a transitory computer-readable medium or a communication medium. By way of an example, and not limitation, a transitory computer-readable medium or a communication medium includes a propagated signal with an electric, an optical, an acoustic, or other form.

Although the present disclosure has been described above with reference to the example embodiments, the present disclosure is not limited to the example embodiments described above. Various modifications may be made to the structure and details of the present disclosure as will be understood by those skilled in the art within the scope of the present disclosure.

For example, in the example embodiment described above, the display device displays the entire graph structure and displays the change of the entire graph structure, but the present disclosure is not limited thereto. For example, the display device may display only one component in the graph structure and a periphery of the component, and may display only a change related to the one component. Alternatively, the display device may display only a plurality of components that are not related to one another in the graph structure and a periphery of the plurality of components, and may display only a change related to the plurality of components.

The first and second embodiments can be combined as desirable by one of ordinary skill in the art.

What is claimed is:

1. A display device comprising:
an input unit that inputs an initial graph structure represented by using a component and a relationship between the two components, and also inputs a conversion content representing a rule for partially converting a graph structure;
a change application unit that refines the initial graph structure by successively applying the conversion content to the initial graph structure, successively applies the conversion content to the initial graph structure while leaving a component deleted in a process of the refinement, and thereby generates an aggregated graph structure equivalent to a graph structure acquired by aggregating, into one graph structure, a plurality of graph structures constituted of the initial graph structure and graph structures each acquired in the process of the refinement; and
a display unit that displays one graph structure of the plurality of graph structures at the same position on a screen, wherein
the change application unit determines a position, on a screen, of the component existing in the aggregated graph structure in such a way that the components existing in the aggregated graph structure do not overlap with each other, in the aggregated graph structure, and
the display unit displays, in display of the one graph structure, the component existing in the one graph structure at the same position, on a screen, as a position determined in the aggregated graph structure.

2. The display device according to claim 1, wherein
the conversion content consists of a pair of partial structures before and after one conversion in a graph structure, and
the same identifier as the component and the relationship in a graph structure to which the conversion content is applied is assigned to the component and the relationship in the conversion content.

3. The display device according to claim 2, wherein the change application unit determines the conversion content to be applied to a graph structure by comparing the identifier.

4. The display device according to claim 1, wherein the display unit successively displays the plurality of graph structures in time series order, as the one graph structure.

5. The display device according to claim 1, wherein the display unit displays the one graph structure selected by a user among the plurality of graph structures.

6. A display method to be executed by a display device, the method comprising:
an input step of inputting an initial graph structure represented by using a component and a relationship between the two components, and also inputting a conversion content representing a rule for partially converting a graph structure;
an application step of refining the initial graph structure by successively applying the conversion content to the initial graph structure, successively applying the conversion content to the initial graph structure while leaving a component deleted in a process of the refinement, and thereby generating an aggregated graph structure equivalent to a graph structure acquired by aggregating, into one graph structure, a plurality of graph structures constituted of the initial graph structure and graph structures each acquired in the process of the refinement; and
a display step of displaying one graph structure of the plurality of graph structures at the same position on a screen, wherein,
in the application step, a position, on a screen, of the component existing in the aggregated graph structure is determined in such a way that the components existing in the aggregated graph structure do not overlap with each other, in the aggregated graph structure, and,
in the display step, in display of the one graph structure, the component existing in the one graph structure is displayed at the same position, on a screen, as a position determined in the aggregated graph structure.

7. A non-transitory computer-readable medium storing a program for causing a computer to execute, the program including:
an input procedure of inputting an initial graph structure represented by using a component and a relationship between the two components, and also inputting a conversion content representing a rule for partially converting a graph structure;
an application procedure of refining the initial graph structure by successively applying the conversion content to the initial graph structure, successively applying the conversion content to the initial graph structure while leaving a component deleted in a process of the refinement, and thereby generating an aggregated graph structure equivalent to a graph structure acquired by aggregating, into one graph structure, a plurality of graph structures constituted of the initial graph structure and graph structures each acquired in the process of the refinement; and
a display procedure of displaying one graph structure of the plurality of graph structures at the same position on a screen, wherein,
in the application procedure, a position, on a screen, of the component existing in the aggregated graph structure is determined in such a way that the components existing in the aggregated graph structure do not overlap with each other, in the aggregated graph structure, and,
in the display procedure, in display of the one graph structure, the component existing in the one graph structure is displayed at the same position, on a screen, as a position determined in the aggregated graph structure.
